(19) United States
(12) Patent Application Publication
(10) Pub. No.: US 2025/0351125 A1
(43) Pub. Date: Nov. 13, 2025

(54) METHODS AND APPARATUSES FOR ENHANCEMENTS OF A DATA DISCARDING OPERATION

(71) Applicant: LENOVO (BEIJING) LIMITED, Beijing (CN)

(72) Inventors: Xiaoying XU, Beijing (CN); Mingzeng DAI, Shanghai (CN); Lianhai WU, Beijing (CN); Congchi ZHANG, Shanghai (CN)

(21) Appl. No.: 18/860,431

(22) PCT Filed: Apr. 27, 2022
(86) PCT No.: PCT/CN2022/089527

§ 371 Date: Oct. 25, 2024

(51) Int. Cl. H04W 72/0446; H04W 72/231; H04W 72/51

(52) U.S. Cl. CPC H04W 72/0446; H04W 72/231; H04W 72/51

(57) ABSTRACT

Embodiments of the subject application relate to methods and apparatuses for enhancements of a data discarding operation. According to an embodiment of the subject application, a user equipment (UE) includes a processor and a transceiver coupled to the processor; and the processor is configured: to determine whether to start a timer associated with at least one of an uplink (UL) data discarding function or a configured grant (CG) prohibiting function or a scheduling request (SR) prohibiting function of the UE; to start the timer, in response to determining to start the timer; and to perform at least one of: discarding UL data for a data radio bearer (DRB) to be transmitted when the timer is running; prohibiting a transmission on a logical channel (LCH) associated with one or more sets of CGs or associated with one or more sets of SR resources configured for the UE when the timer is running; or prohibiting a trigger of a SR for the LCH associated with the one or more sets of CGs or associated with the one or more sets of SR resources when the timer is running.

### TECHNICAL FIELD

Embodiments of the subject application generally relate to wireless communication technology, in particular to methods and apparatuses for enhancements of a data discarding operation.

### BACKGROUND

Extended reality (XR), including augmented reality (AR) and virtual reality (VR), as well as cloud gaming (CG), presents a new promising category of connected devices, applications, and services. As a potential working area of 3GPP (3rd generation partnership project) Rel-18, application and traffic awareness in radio access network (RAN) is one of key feature to improve user experience of XR services. Currently, details regarding enhancements of a data discarding operation (e.g., a frame discarding operation) have not been discussed yet.

### SUMMARY

Some embodiments of the subject application also provide a user equipment (UE). The UE includes a processor and a transceiver coupled to the processor; and the processor is configured: to determine whether to start a timer associated with at least one of an uplink (UL) data discarding function or a configured grant (CG) prohibiting function or a scheduling request (SR) prohibiting function of the UE; to start the timer, in response to determining to start the timer; and to perform at least one of: discarding UL data for a data radio bearer (DRB) to be transmitted when the timer is running; prohibiting a transmission on a logical channel (LCH) associated with one or more sets of CGs or associated with one or more sets of SR resources configured for the UE when the timer is running; or prohibiting a trigger of a SR for the LCH associated with the one or more sets of CGs or associated with the one or more sets of SR resources when the timer is running.

In some embodiments, the processor of the UE is configured: to determine whether a discarding command corresponding to the DRB or a prohibiting command corresponding to the LCH is received; and in response to determining that the discarding command or the prohibiting command is received, to determine to start the timer.

In some embodiments, in response to determining to start the timer, the processor of the UE is configured: to determine a start time instance of the timer in a time domain; and to determine a length of the timer.

In some embodiments, the start time instance is: a time instance of receiving a notification via the transceiver from a network; a time offset after the time instance of receiving the notification; an absolute start time instance included in the notification; or configured by the network via radio resource control (RRC) signalling.

In some embodiments, the notification is a discarding command corresponding to the DRB or a prohibiting command corresponding to the LCH.

In some embodiments, the time offset is a default value or configured by the network.

In some embodiments, the length of the timer is: a default value; configured by the network via radio resource control (RRC) signalling; configured by the network via a medium access control (MAC) control element (CE); or included in the notification.

In some embodiments, the processor of the UE is configured to receive a first configuration via the transceiver from a network, and wherein the first configuration includes at least one of: the start time instance of the timer; or the length of the timer.

In some embodiments, the processor of the UE is configured to receive a second configuration via the transceiver from a network, and wherein the second configuration includes one of: information for enabling the UL data discarding function; and a configuration regarding the timer.

In some embodiments, the processor of the UE is configured to receive a discarding command corresponding to the DRB via the transceiver from the network.

In some embodiments, the discarding command includes at least one of: identity (ID) information of the DRB; ID information of a slice in a frame to be transmitted when the timer is running; a start time instance of the timer; a length of the timer; a scale factor associated with the length of the timer; or a period associated with the scale factor.

In some embodiments, the processor of the UE is configured: in response to the discarding command including the ID information of the DRB, to discard one or more PDCP service data units (SDUs) along with one or more PDCP PDUs on the DRB; or in response to the discarding command including the ID information of the slice, to discard one or more PDCP SDUs on a DRB to which the slice belongs.

In some embodiments, the processor of the UE is configured to receive a prohibiting command corresponding to the LCH via the transceiver from the network.

In some embodiments, the prohibiting command includes at least one of: identity (ID) information of the LCH of the DRB; index information of the one or more sets of CGs; a start time instance of the timer; a length of the timer; a scale factor associated with the length of the timer; or a period associated with the scale factor.

In some embodiments, the prohibiting command is received via RRC signalling, a packet data convergence protocol (PDCP) control protocol data unit (PDU), a medium access control (MAC) control element (CE), or downlink control information (DCI).

In some embodiments, the processor of the UE is configured: to determine whether data on a first DRB is too late to be transmitted within a delay budget; and in response to determining that the data on the first DRB is too late to be transmitted within the delay budget, to determine to start the timer.

In some embodiments, the processor of the UE is configured: to discard the data on the first DRB when the timer is running; or to discard data on a second DRB correlated to the first DRB when the timer is running.

In some embodiments, in response to determining that the data on the first DRB is too late to be transmitted within the delay budget, the processor of the UE is configured: to transmit a discarding indication by a PDCP entity of the first DRB of the UE to an RRC entity of the UE; to transmit the discarding indication by the RRC entity of the UE to a PDCP entity of a second DRB correlated to the first DRB; and to start the timer by the PDCP entity of the second DRB upon receiving the discarding indication from the RRC entity of the UE.

In some embodiments, the processor of the UE is configured: to determine whether data on the LCH of a first DRB associated with the one or more sets of CGs is too late to be transmitted within a delay budget; and in response to determining that the data on the LCH of the first DRB is too late to be transmitted within the delay budget, to determine to start the timer.

In some embodiments, the processor of the UE is configured: to prohibit a transmission of the data on the LCH of the first DRB associated with the one or more sets of CGs when the timer is running; or to prohibit a transmission of data on a LCH of a second DRB associated with the one or more sets of CGs when the timer is running.

In some embodiments, in response to determining that the data on the LCH of the first DRB is too late to be transmitted within the delay budget, the processor of the UE is configured: to transmit a prohibiting indication by a PDCP entity of the first DRB of the UE to an RRC entity of the UE; to transmit the prohibiting indication by the RRC entity of the UE to a MAC entity of the UE; and to start the timer by the MAC entity of the UE upon receiving the prohibiting indication from the RRC entity of the UE.

In some embodiments, the processor of the UE is configured: to transmit information regarding a LCH of a second DRB correlated to the first DRB by the RRC entity of the UE to a MAC entity of the UE; and to start the timer by the MAC entity of the UE upon receiving both the prohibiting indication and the information regarding the LCH of the second DRB from the RRC entity of the UE.

In some embodiments, the length of the timer is: associated with at least one of a size of a group of frames (GOP) and a frame arrival period; pre-configured to the UE; dynamically set by the RRC entity of the UE; dynamically set by the PDCP entity of the first DRB; or dynamically set by the PDCP entity of the second DRB.

In some embodiments, the processor of the UE is configured to receive a third configuration via the transceiver from a network, and wherein the third configuration includes at least one of: a length of the timer; correlation information between two or more DRBs; a size of a group of frames (GOP); a maximum number of previous frames to which a frame is correlated; a total number of frames in the GOP between a first frame and a second frame correlated to the first frame; a frame arrival period; or frame arrival time of an initial packet of a UL data burst.

In some embodiments, the processor of the UE is configured to transmit a prohibiting report via the transceiver to the network, and wherein the prohibiting report includes at least one of: information regarding the one or more sets of CGs; a start time instance of the timer; or a length of the timer.

In some embodiments, at least one of the first configuration, the second configuration, or the third configuration is received via a radio resource control (RRC) message.

In some embodiments, the UL data includes at least one of: a set of slices; a set of frames; a set of internet protocol (IP) packets; a set of service data units (SDUs); a set of protocol data units (PDUs); a UL data burst; or a set of application data units (ADUs).

Some embodiments of the subject application provide a method, which may be performed by a UE. The method includes: determining whether to start a timer associated with at least one of an uplink (UL) data discarding function or a configured grant (CG) prohibiting function or a scheduling request (SR) prohibiting function of the UE; starting the timer, in response to determining to start the timer; and performing at least one of: discarding UL data for a data radio bearer (DRB) to be transmitted when the timer is running; prohibiting a transmission on a logical channel (LCH) associated with one or more sets of CGs or associated with one or more sets of SR resources configured for the UE when the timer is running; or prohibiting a trigger of a SR for the LCH associated with the one or more sets of CGs or associated with the one or more sets of SR resources when the timer is running.

Some embodiments of the subject application also provide a network node (e.g., a base station (BS)). The network node includes a processor and a transceiver coupled to the processor; and the processor is configured: to receive a capability supporting at least one of uplink (UL) data discarding or configured grant (CG) prohibiting or scheduling request (SR) prohibiting of a user equipment (UE) via the transceiver from the UE; and to transmit a first configuration for enabling at least one of a UL data discarding function or a CG prohibiting function of the UE via the transceiver to the UE.

In some embodiments, the processor of the network node is configured to receive a configuration of traffic characters related to a quality of service (QoS) flow from a core network.

In some embodiments, the configuration of traffic characters includes at least one of: a size of a group of frames (GOP); a maximum number of previous frames to which a frame is correlated; a total number of frames in the GOP between a first frame and a second frame correlated to the first frame; frame arrival time of an initial packet of a UL data burst; a frame arrival period; a UL data burst arrival period; or a PDU set arrival period.

In some embodiments, the processor of the network node is configured to transmit a second configuration regarding a timer via the transceiver to the UE.

In some embodiments, the second configuration includes at least one of: the start time instance of the timer; or the length of the timer.

In some embodiments, the start time instance is: a time instance of transmitting a notification via the transceiver to the UE; a time offset after the time instance of transmitting the notification; or an absolute start time instance included in the notification.

In some embodiments, the notification is a discarding command corresponding to a data radio bearer (DRB) or a prohibiting command corresponding to a logical channel (LCH) associated with one or more sets of configured grants (CGs) or associated with one or more sets of SR resources.

In some embodiments, the time offset is a default value or configured by the network node.

In some embodiments, the length of the timer is: a default value; configured by the network node via radio resource control (RRC) signalling; configured by the network node via a medium access control (MAC) control element (CE); included in the notification; associated with at least one of a size of a group of frames (GOP) and a frame arrival period; pre-configured to the UE; dynamically set by an RRC entity of the UE; dynamically set by a PDCP entity of a first DRB; or dynamically set by a PDCP entity of a second DRB correlated to the first DRB.

In some embodiments, the processor of the network node is configured to transmit a third configuration via the transceiver to the UE, and wherein the third configuration includes at least one of: a length of a timer; correlation information between two or more DRBs; a size of a group of frames (GOP); a maximum number of previous frames to which a frame is correlated; a total number of frames in the GOP between a first frame and a second frame correlated to the first frame; a frame arrival period; or frame arrival time of an initial packet of a UL data burst.

In some embodiments, at least one of the first configuration, the second configuration, or the third configuration is transmitted via a radio resource control (RRC) message.

In some embodiments, the processor of the network node is configured to transmit a discarding command corresponding to a data radio bearer (DRB) via the transceiver to the UE.

In some embodiments, the discarding command includes at least one of: identity (ID) information of the DRB; ID information of a slice in a frame; a start time instance of a timer; a length of the timer; a scale factor associated with the length of the timer; or a period associated with the scale factor.

In some embodiments, the processor of the network node is configured to transmit a prohibiting command corresponding to a logical channel (LCH) associated with one or more sets of configured grants (CGs) or associated with one or more sets of SR resources via the transceiver to the UE.

In some embodiments, the prohibiting command includes at least one of: identity (ID) information of the LCH; index information of the one or more sets of CGs; a start time instance of a timer; a length of the timer; a scale factor associated with the length of the timer; or a period associated with the scale factor.

In some embodiments, the prohibiting command is transmitted via RRC signalling, a packet data convergence protocol (PDCP) control PDU, a medium access control (MAC) control element (CE), or downlink control information (DCI).

In some embodiments, the processor of the network node is configured to receive a prohibiting report via the transceiver from the UE, and wherein the prohibiting report includes at least one of: information regarding one or more sets of CGs associated with the CG prohibiting function; a start time instance of a timer; or a length of the timer.

In some embodiments, the UL data discarding function is associated with at least one of: a set of slices; a set of frames; a set of internet protocol (IP) packets; a set of service data units (SDUs); a set of protocol data units (PDUs); a UL data burst; or a set of application data units (ADUs).

Some embodiments of the subject application provide a method, which may be performed by a network node (e.g., a BS). The method includes: receiving a capability supporting at least one of uplink (UL) data discarding or configured grant (CG) prohibiting or scheduling request (SR) prohibiting of a user equipment (UE) from the UE; and transmitting a first configuration for enabling at least one of a UL data discarding function or a CG prohibiting function of the UE to the UE.

Some embodiments of the subject application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned methods performed by a UE or a network node (e.g., a BS).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1A illustrates a schematic diagram of a wireless communication system in accordance with some embodiments of the subject application.

FIG. 1B illustrates an exemplary schematic diagram of a slice based traffic model in accordance with some embodiments of the subject application.

FIG. 1C illustrates an exemplary schematic diagram of a group of picture (GOP) based traffic model in accordance with some embodiments of the subject application.

FIG. 2 illustrates an exemplary flowchart regarding a UL data discarding function or a CG prohibiting function in accordance with some embodiments of the subject application.

FIG. 3 illustrates an exemplary flowchart regarding a UL data discarding function or a CG prohibiting function in accordance with some embodiments of the subject application.

FIG. 4A illustrates an exemplary RAN protocol architecture in accordance with some embodiments of the subject application.

FIG. 4B illustrates an exemplary schematic diagram of a GOP based traffic model in accordance with some embodiments of the subject application.

FIGS. 5A-5D illustrate exemplary MAC CE and PDCP control PDU including a discarding command in accordance with some embodiments of the subject application.

FIGS. 6A-6C illustrate exemplary MAC CE and PDCP control PDU including a prohibiting command in accordance with some embodiments of the subject application.

FIG. 6D illustrates an exemplary flow chart of a frame discard notification between two DRBs in accordance with some embodiments of the subject application.

FIG. 7 illustrates an exemplary block diagram of an apparatus for a data discarding operation in accordance with some embodiments of the subject application.

FIG. 8 illustrates a further exemplary block diagram of an apparatus for a data discarding operation in accordance with some embodiments of the subject application.

### DETAILED DESCRIPTION

The detailed description of the appended drawings is intended as a description of preferred embodiments of the subject application and is not intended to represent the only form in which the subject application may be practiced. It should be understood that the same or equivalent functions may be accomplished by different embodiments that are intended to be encompassed within the spirit and scope of the subject application.

Reference will now be made in detail to some embodiments of the subject application, examples of which are illustrated in the accompanying drawings. To facilitate understanding, embodiments are provided under specific network architecture and new service scenarios, such as 3rd Generation Partnership Project (3GPP) LTE and LTE advanced, 3GPP 5G NR, 5G-Advanced, 6G, and so on. It is contemplated that along with developments of network architectures and new service scenarios, all embodiments in the subject application are also applicable to similar technical problems; and moreover, the terminologies recited in the subject application may change, which should not affect the principle of the subject application.

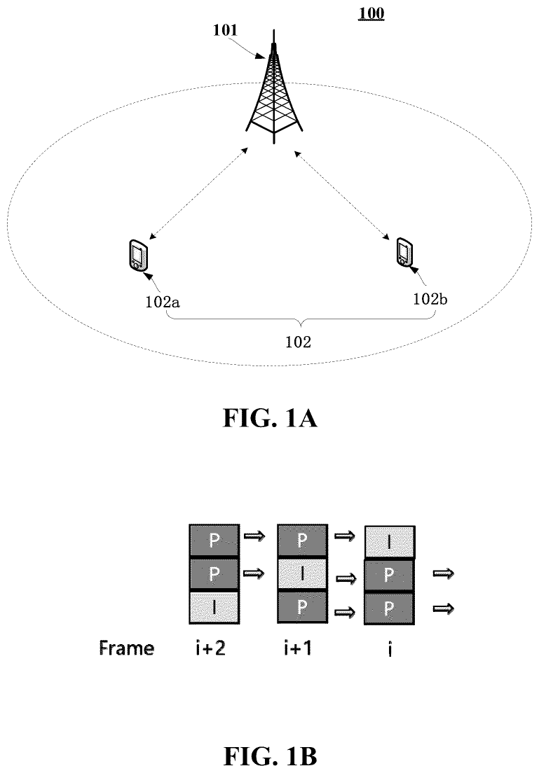

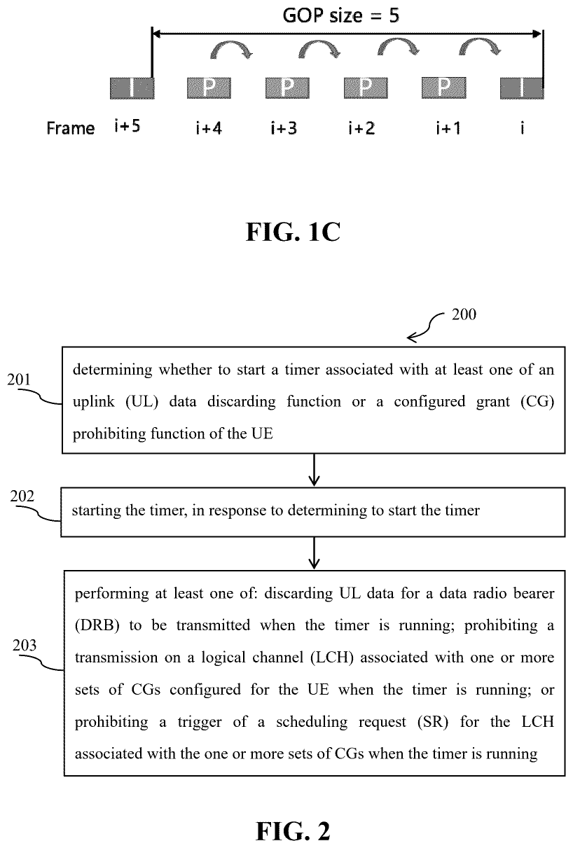

FIG. 1A illustrates a schematic diagram of a wireless communication system in accordance with some embodiments of the subject application.

As shown in FIG. 1A, the wireless communication system 100 includes at least one base station (BS) 101 and at least one UE 102. In particular, the wireless communication system 100 includes one BS 101 and two UEs 102 (e.g., a UE 102a and a UE 102b) for illustrative purpose. Although a specific number of BS 101 and UEs 102 are depicted in FIG. 1A, it is contemplated that any number of BSs 101 and UEs 102 may be included in the wireless communication system 100.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

BS 101 may also be referred to as a NG-RAN node, a RAN node, an access point, an access terminal, a base, a macro cell, a node-B, an enhanced node B (eNB), a gNB, a home node-B, a relay node, or a device, or described using other terminology used in the art. The BS 101 is generally part of a radio access network that may include a controller communicably coupled to BS 101.

According to some embodiments of the subject application, UE(s) 102 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some other embodiments of the subject application, UE(s) 102 may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the subject application, UE(s) 102 may include wearable devices, such as smart watches, fitness bands, optical head-mounted displays, or the like. Moreover, UE(s) 102 may be referred to as a subscriber unit, a mobile, a mobile station, a user, a terminal, a mobile terminal, a wireless terminal, a fixed terminal, a subscriber station, a user terminal, or a device, or described using other terminology used in the art.

Both UE 102a and UE 102b in the embodiments of FIG. 1A may transmit information to BS 101 and receive control information from BS 101, for example, via LTE or NR Uu interface.

XR, including AR and VR, as well as CG, presents a new promising category of connected devices, applications, and services. A UE with an XR service can be referred to as an XR device. The XR traffic characteristic parameters may include GOP size, frame arrival period, frame importance, inter-frame correlation.

According to 3GPP standard documents, depending on the video encoding scheme for XR traffic, two additional sub models: a slice based model, and a Group of Picture (GOP) based model are defined.
(1) Slice-based model: in this encoding scheme, a single video frame is divided into N slices. Out of N, one slice is I slice and remaining N−1 slices are P slices. N slices correspond to one video frame arriving at the same time. The I slice is coded or decoded independently. The k-th P slice in one frame is coded or decoded dependently of the k-th slice in the previous video frame. For example, N=3 in FIG. 1B.
(2) GOP-based model: in this encoding scheme, a single video frame is either I frame or P frame. I frame is transmitted every K frames, where K is the GOP size, i.e., every group of pictures. I frame is coded or decoded dependently of itself. P-frame is coded or decoded dependently of the previous video frame. For example, K=5 in FIG. 1C. Within a GOP, the later P-frame is correlated to the previous frame.

FIG. 1B illustrates an exemplary schematic diagram of a slice based traffic model in accordance with some embodiments of the subject application. As shown in FIG. 1B, a single video frame is divided into 3 slices. For instance, each of Frames i, i+1, and i+2 is divided into one I slice and two P slices. The arrows in FIG. 1B represent dependent relationships between the slices of the frames.

FIG. 1C illustrates an exemplary schematic diagram of a group of picture (GOP) based traffic model in accordance with some embodiments of the subject application. As shown in FIG. 1C, the GOP size is 5, and I frame is transmitted every 5 frames. Within the GOP, P-frame i+4 is correlated to P-frame i+3, P-frame i+3 is correlated to P-frame i+2, P-frame i+2 is correlated to P-frame i+1, and P-frame i+1 is correlated to I-frame i.

Typically, for XR services, a group of internet protocol (IP) packets would be used to carry payloads of a PDU set (e.g., a video frame or video slice) and the size of a PDU set is variable. In an application layer, packets in such a PDU set should be handled as a whole, i.e., the groups of packets within the PDU set have inherent dependency on each other.

There is a case that the GOP is seen as an application data unit (ADU). The later PDU set is correlated to the previous PDU set within an ADU. One PDU set is composed of multiple IP packets. One IP packet corresponds to a PDCP SDU or a PDCP PDU. If one or some of PDU sets (e.g., frame or slice) within an ADU transmission fails, the later PDU sets within the whole ADU cannot be decoded by the application layer successfully. In this case, other correlated PDU set(s) in the ADU should be discarded. However, it is possible that a BS and a UE do not aware ADU information. In this case, an issue of how to discard other correlated PDU set(s) within the ADU needs to be addressed.

In general, it is challengeable to support the correlation packet discarding operation for uplink (UL) transmission(s) in the following cases:
(1) Case 1: if one packet in a PDU set is failed for transmission, a UE discards the packet in the correlated PDU set. An issue needs to be addressed is that the UE cannot trigger the correlation frame discarding procedure by itself, because the UE is unaware of the packet transmission failure in an unacknowledged mode (UM) radio link control (RLC) mode.
(2) Case 2: if one packet in a PDU set is too late to be transmitted due to an expiry of a PDCP discard timer, a UE discards the PDCP SDU and along with the corresponding PDCP PDU, which is too late to be transmitted, and further discards the packets in the correlation PDU set. An issue of how to identify the correlation frame to be discarded should be addressed with considering the complexity and cost aspect.

To resolve the abovementioned issues, embodiments of the subject application design a mechanism for an enhancement of the correlation data discarding operation for a UL transmission of the XR traffic.

More specifically, some embodiments of the subject application introduce a mechanism to support an enhancement of a data discarding operation for a UL XR service. In some embodiments of the subject application, a UE performs a correlation PDCP SDU discarding operation according to a discarding command from a BS in a period. The discarding command may be used to indicate a specific DRB, a specific slice, and a start time instance and a length of a discarding timer. Upon receiving the discarding command, the PDCP entity of the UE may discard PDCP SDU(s) on the specific DRB indicated in the discarding command.

In some embodiments of the subject application, a UE skips a transmission on a LCH with a CG according to a prohibiting command from a BS in a period. The prohibiting command may be used to indicate the LCH, the set of CG, and a start time instance and a length of a prohibiting timer. Upon receiving the prohibiting command, the MAC entity of the UE may start the prohibiting timer. While the prohibiting timer is running, the UE may skip the transmission on the LCH with the allowed CG configured by an RRC message, and the UE may prohibit triggering a SR corresponding to the LCH.

In some embodiments of the subject application, a UE discards the correlation PDCP SDU on the correlation DRB of a DRB when the previous PDCP SDU on the DRB is too late to be transmitted in a period. The UE may send a prohibiting report to a BS.

In some embodiments of the subject application, a UE skips the transmission on a LCH of the correlation DRB of a DRB with the allowed CG in a period when the PDCP SDU on the LCH of the DRB is too late to be transmitted. The UE sends a prohibiting report to a BS.

More details will be illustrated in the following text in combination with the appended drawings. Persons skilled in the art should well know that the wording “a/the first,” “a/the second” and “a/the third” etc. are only used for clear description, and should not be deemed as any substantial limitation, e.g., sequence limitation.

FIG. 2 illustrates an exemplary flowchart regarding a UL data discarding function or a CG prohibiting function in accordance with some embodiments of the subject application. The exemplary method 200 in FIG. 2 may be performed by a UE, e.g., UE 102 as shown in FIG. 1A. Although described with respect to a UE, it should be understood that other devices may be configured to perform a method similar to that of FIG. 2.

In the exemplary method 200 in FIG. 2, in operation 201, a UE determines whether to start a timer associated with at least one of a UL data discarding function or a CG prohibiting function or a SR prohibiting function of the UE. In operation 202, the UE starts the timer, in response to determining to start the timer. In operation 203, the UE performs at least one of: discarding UL data for a DRB to be transmitted when the timer is running; prohibiting a transmission on a LCH associated with one or more sets of CGs or associated with one or more sets of SR resources configured for the UE when the timer is running; or prohibiting a trigger of a SR for the LCH associated with the one or more sets of CGs or associated with the one or more sets of SR resources when the timer is running.

In some embodiments, the UE determines whether a discarding command corresponding to the DRB or a prohibiting command corresponding to the LCH is received. In response to determining that the discarding command or the prohibiting command is received, the UE determines to start the timer.

In some embodiments, in response to determining to start the timer, the UE determines a start time instance of the timer in a time domain, and determines a length of the timer.

In an embodiment, the start time instance may be a time instance of receiving a notification from a network (e.g., BS 101 as shown in FIG. 1A), or may be a time offset after the time instance of receiving the notification. The notification may be a discarding command corresponding to the DRB or a prohibiting command corresponding to the LCH. The time offset is a default value or configured by the network. In a further embodiment, the start time instance may be an absolute start time instance included in the notification, or may be configured by the network via RRC signalling.

In an embodiment, the length of the timer is: a default value; configured by the network via RRC signalling; configured by the network via a MAC CE; or included in the notification.

In some embodiments, the UE receives a configuration from a network, which includes at least one of: the start time instance of the timer; or the length of the timer. The configuration may be received via an RRC message.

In some further embodiments, the UE receives a further configuration from a network, which includes one of: information for enabling the UL data discarding function; and a configuration regarding the timer. The further configuration may be received via an RRC message.

In some embodiments, the UE receives a discarding command corresponding to the DRB from the network. The discarding command may include at least one of: ID information of the DRB; ID information of a slice in a frame to be transmitted when the timer is running; a start time instance of the timer; a length of the timer; a scale factor associated with the length of the timer; or a period associated with the scale factor. In an embodiment, in response to the discarding command including the ID information of the DRB, the UE discards one or more PDCP SDUs along with one or more PDCP PDUs on the DRB. In a further embodiment, in response to the discarding command including the ID information of the slice, the UE discards one or more PDCP SDUs on a DRB to which the slice belongs.

In some embodiments, the UE receives a prohibiting command corresponding to the LCH from the network. The prohibiting command may include at least one of: ID information of the LCH of the DRB; index information of the one or more sets of CGs; a start time instance of the timer; a length of the timer; a scale factor associated with the length of the timer; or a period associated with the scale factor. In an embodiment, the prohibiting command is received via RRC signalling, a PDCP control PDU, a MAC CE, or DCI.

In some embodiments, the UE determines whether data on a DRB is too late to be transmitted within a delay budget. In response to determining that the data on the DRB is too late to be transmitted within the delay budget, the UE determines to start the timer. In an embodiment, the UE discards the data on the DRB when the timer is running. In a further embodiment, the UE discards data on a further DRB correlated to the DRB when the timer is running.

In some embodiments, in response to determining that the data on the DRB is too late to be transmitted within the delay budget, the UE transmits a discarding indication by a PDCP entity of the DRB of the UE to an RRC entity of the UE, transmits the discarding indication by the RRC entity of the UE to a PDCP entity of a further DRB correlated to the first DRB, and starts the timer by the PDCP entity of the further DRB upon receiving the discarding indication from the RRC entity of the UE.

In some embodiments, the UE determines whether data on the LCH of a first DRB associated with the one or more sets of CGs is too late to be transmitted within a delay budget. In response to determining that the data on the LCH of the first DRB is too late to be transmitted within the delay budget, the UE determines to start the timer.

In an embodiment, the UE prohibits a transmission of the data on the LCH of the DRB associated with the one or more sets of CGs when the timer is running. In a further embodiment, the UE prohibits a transmission of data on a LCH of a further DRB associated with the one or more sets of CGs when the timer is running.

In some embodiments, in response to determining that the data on the LCH of the DRB is too late to be transmitted within the delay budget, the UE transmits a prohibiting indication by a PDCP entity of the first DRB of the UE to an RRC entity of the UE, transmits the prohibiting indication by the RRC entity of the UE to a MAC entity of the UE, and starts the timer by the MAC entity of the UE upon receiving the prohibiting indication from the RRC entity of the UE.

In some embodiments, the UE transmits information regarding a LCH of a further DRB correlated to the DRB by the RRC entity of the UE to a MAC entity of the UE, and starts the timer by the MAC entity of the UE upon receiving both the prohibiting indication and the information regarding the LCH of the further DRB from the RRC entity of the UE.

In some embodiments, the length of the timer is: associated with at least one of a size of a GOP and a frame arrival period; pre-configured to the UE; dynamically set by the RRC entity of the UE; dynamically set by the PDCP entity of the first DRB; or dynamically set by the PDCP entity of the second DRB.

In some embodiments, the UE receives another configuration from a network, which includes at least one of: a length of the timer; correlation information between two or more DRBs; a size of a GOP; a maximum number of previous frames to which a frame is correlated; a total number of frames in the GOP between a frame and a further frame correlated to the frame; a frame arrival period; or frame arrival time of an initial packet of a UL data burst. The configuration may be received via an RRC message.

In some embodiments, the UE transmits a prohibiting report to the network. The prohibiting report includes at least one of: information regarding the one or more sets of CGs; a start time instance of the timer; or a length of the timer.

In some embodiments, the UL data includes at least one of: a set of slice(s); a set of frame(s); a set of IP packet(s); a set of SDU(s); a set of PDU(s); a UL data burst; or a set of ADU(s).

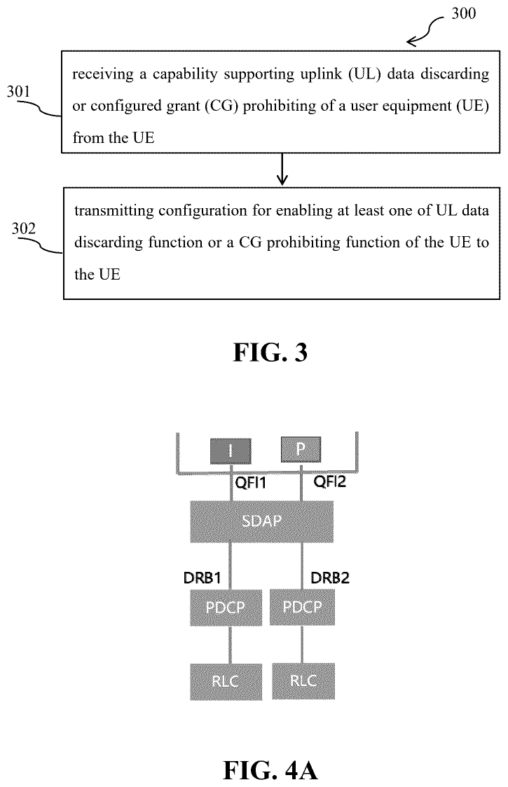

FIG. 3 illustrates an exemplary flowchart regarding a UL data discarding function or a CG prohibiting function in accordance with some embodiments of the subject application. The exemplary method 300 in FIG. 3 may be performed by a BS, e.g., BS 101 as shown in FIG. 1A. Although described with respect to a BS, it should be understood that other devices may be configured to perform a method similar to that of FIG. 3.

In the exemplary method 300 in FIG. 3, in operation 301, a BS receives a capability supporting at least one of UL data discarding or CG prohibiting or SR prohibiting of a UE (e.g., UE 102 as shown in FIG. 1A) from the UE. In operation 302, the BS transmits a configuration for enabling at least one of a UL data discarding function or a CG prohibiting function of the UE to the UE. The configuration may be transmitted via an RRC message.

In some embodiments, the network node receives a configuration of traffic characters related to a QoS flow from a core network. The configuration of traffic characters may include at least one of: a size of a GOP; a maximum number of previous frames to which a frame is correlated; a total number of frames in the GOP between a frame (e.g., frame #1) and a further frame (e.g., frame #2) correlated to the frame (e.g., frame #1); frame arrival time of an initial packet of a UL data burst; a frame arrival period; a UL data burst arrival period; or a PDU set arrival period.

In some embodiments, the network node transmits a further configuration regarding a timer to the UE, which may include at least one of: the start time instance of the timer; or the length of the timer. The further configuration may be transmitted via an RRC message.

In an embodiment, the start time instance is: a time instance of transmitting a notification to the UE; a time offset after the time instance of transmitting the notification; or an absolute start time instance included in the notification. The notification may be a discarding command corresponding to a DRB or a prohibiting command corresponding to a LCH associated with one or more sets of CGs or associated with one or more sets of SR resources. The time offset may be a default value or configured by the network node.

In some embodiments, the length of the timer is: a default value; configured by the network node via RRC signalling; configured by the network node via a MAC CE; included in the notification; associated with at least one of a size of a GOP and a frame arrival period; pre-configured to the UE; dynamically set by an RRC entity of the UE; dynamically set by a PDCP entity of a first DRB; or dynamically set by a PDCP entity of a second DRB correlated to the first DRB.

In some embodiments, the network node transmits another configuration to the UE, which includes at least one of: a length of a timer; correlation information between two or more DRBs; a size of a GOP; a maximum number of previous frames to which a frame is correlated; a total number of frames in the GOP between a first frame and a second frame correlated to the first frame; a frame arrival period; or frame arrival time of an initial packet of a UL data burst. The configuration may be transmitted via an RRC message.

In some embodiments, the network node transmits a discarding command corresponding to a DRB to the UE. The discarding command may include at least one of: ID information of the DRB; ID information of a slice in a frame; a start time instance of a timer; a length of the timer; a scale factor associated with the length of the timer; or a period associated with the scale factor.

In some embodiments, the network node transmits a prohibiting command corresponding to a LCH associated with one or more sets of CGs or associated with one or more sets of SR resources to the UE. The prohibiting command may include at least one of: ID information of the LCH; index information of the one or more sets of CGs; a start time instance of a timer; a length of the timer; a scale factor associated with the length of the timer; or a period associated with the scale factor. The prohibiting command may be transmitted via RRC signalling, a PDCP control PDU, a MAC CE, or DCI.

In some embodiments, the network node receives a prohibiting report from the UE, which includes at least one of: information regarding one or more sets of CGs associated with the CG prohibiting function; a start time instance of a timer; or a length of the timer.

In some embodiments, the UL data discarding function is associated with at least one of: a set of slice(s); a set of frame(s); a set of IP packet(s); a set of SDU(s); a set of PDU(s); a UL data burst; or a set of ADU(s).

It should be appreciated by persons skilled in the art that the sequence of the operations in the exemplary flowcharts 200 and 300 may be changed, and some of the operations in the exemplary flowcharts 200 and 300 may be eliminated or modified, without departing from the spirit and scope of the disclosure. Details described in all other embodiments of the subject application, e.g., in the embodiments of FIGS. 2 and 3 are applicable for this exemplary flowchart. Moreover, details described in this exemplary flowchart are applicable for all the embodiments of FIGS. 1A-1C and 4A-8.

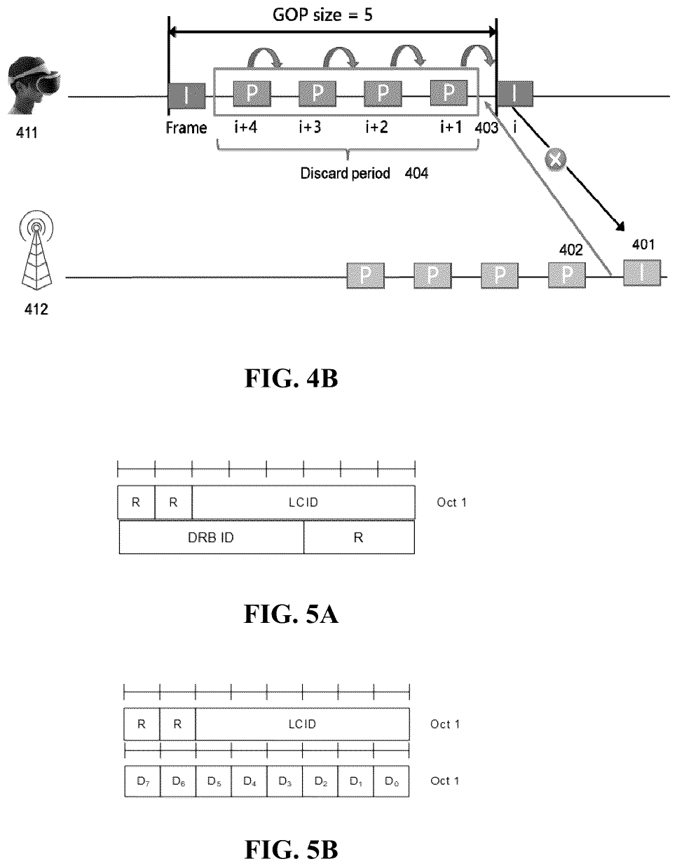

FIG. 4A illustrates an exemplary RAN protocol architecture in accordance with some embodiments of the subject application. As shown in FIG. 4A, for a XR transmission, I-frame and P-frame are routed to the different two QoS flows, i.e., QFI1 and QFI2, and are further mapped to different DRBs, i.e., DRB1 and DRB2, by a service data adaptation protocol (SADP) layer In some cases, for a XR transmission, I-frame and P-frame are routed to the same QoS flow (e.g., QFI1 or QFI2) and are further mapped to the same DRB (e.g., DRB1 or DRB2), may be further mapped to the same LCH or different LCHs.

In some embodiments of the subject application, when a BS detects that IP packet(s) of a frame from a UE are not received completely within a delay budget, the BS may send a data discarding command to indicate the UE to discard the IP packets of the correlation frames in the future. The correlation frame is decoded dependent of the incompletely received frame. After the UE receives the data discarding command, the UE may discard the IP packets of the future arriving correlation frame within a certain period. These embodiments may be applicable for different data transmission formats. For example, a frame can be replaced with a PDU set, a burst or an ADU. A PDU Set is composed of one or more PDUs carrying the payload of one unit of information generated at the application level, which are of same importance requirement at application layer. The IP packet can be replaced with the PDCP SDU or PDCP PDU. A data discarding command may also be named as “a discarding command” or “a frame discarding command” or “a slice discarding command” or “a burst discarding command” or the like, in different embodiments.

In an embodiment, a discarding command is used to indicate a specific DRB. A BS can send a discarding command by RRC signalling, PDCP control PDU, MAC CE, or DCI. Upon receiving the discarding command, the PDCP entity of the DRB starts a data discarding timer immediately or after a time offset. The time offset may be a default value or configured by the network by an RRC message. It is an offset relative to the time when the PDCCH schedules the PDSCH carrying the discarding command or when the PDSCH carrying the discarding command is received. While the data discarding timer is running, the PDCP entity discards the future arriving PDCP SDUs on the DRB indicated in the discarding command. The length of the data discarding timer may be previously configured by the network via RRC message. The timer length of a data discarding timer may be “a frame arrival period” or “GOP size multiplied by the frame arrival period”. A specific example is described in the embodiments of FIG. 4B as below.

FIG. 4B illustrates an exemplary schematic diagram of a GOP based traffic model in accordance with some embodiments of the subject application. The embodiments of FIG. 4B assume that a BS receives XR traffic characteristic parameter(s) per a QoS flow from the application server in a PDU session resource setup request message, which may include at least one of following parameters:
(1) A GOP size, which indicates the interval between the adjacent I-frames. A default value of the GOP size is 8.
(2) An inter-frame correlation number, which indicates a maximum number of previous frames to which a frame is correlated, or a total number of frames in the GOP between a frame (e.g., frame #1) and a further frame (e.g., frame #2) correlated to the frame (e.g., frame #1). A default value of the inter-frame correlation number is 1.
(3) A frame arrival period.
(4) A frame arrival time of an initial packet of a UL data burst, which indicates the latest possible time when the initial packet of the UL data burst arrives at the egress interface of the UE (i.e., the uplink flow direction).
(5) A UL data burst arrival period.
(6) A PDU set arrival period.

The embodiments of FIG. 4B assume that I-frame and P-frame for a XR transmission are routed to QFI1 and QFI2 and are further mapped to DRB1 and DRB2 as shown in FIG. 4A.

As shown in FIG. 4B, in operation 401, BS 412 sends a frame discarding configuration about DRB2 to UE 411 in an RRC reconfiguration message. For example, the frame discarding configuration is used to enable the frame discarding function for UE 411. For instance, the frame discarding configuration may include FrameDidscardTimer information element (IE).

In operation 402, BS 412 determines that IP packet(s) of a frame on DRB1 are not received completely from UE 411, and further determines the impacted correlation frames on DRB2 in the future. For an example, BS 412 detects that IP packet(s) of a frame on DRB1 are not received completely within the delay budget. Then, BS 412 may determine the frame is I-frame based on XR traffic characteristic parameter(s). One possibility is that BS 412 sets a length of a data discarding timer to “(GOP size-j) multiplied by a period” according to the GOP size and the inter-frame correlation number. Wherein “j” is the ascending order of the frame in this GOP, and the period is a frame arrival period. In the embodiments of FIG. 4B, j=1.

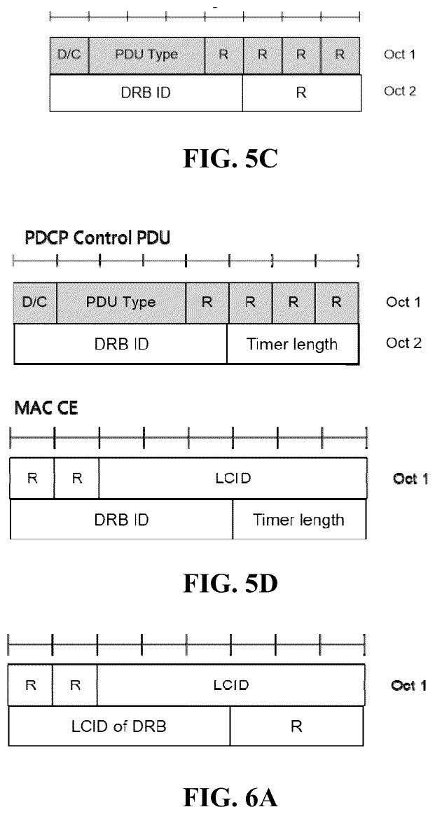

In operation 403, BS 412 sends a discarding command to UE 411. The discarding command includes data discarding information, which is used to indicate DRB2. In the embodiments of FIG. 4B, BS 412 sends the discarding command to UE 411 every period, and there are 4 times in total. Exemplary formats of the discarding command are described in the embodiments of FIGS. 5A-5D as below.

Upon receiving the discarding command from BS 412, the PDCP entity of DRB2 (which is indicated in the discarding command) of UE 411 starts the data discarding timer immediately or after a time offset. For example, the time offset may be a default value or configured by the network by an RRC message. For example, the length of the data discarding timer is previously configured by an RRC message. For instance, if the discarding command is a MAC CE, the MAC entity of UE 411 indicates the data discarding information to the PDCP entity of DRB2. A data discarding operation may also be named as “a frame discarding operation” or “a slice discarding operation” or “a SDU discarding operation” or the like in different embodiments.

In an embodiment, regarding a frame discarding operation:
(1) If one or more DRBs are configured with a frame discarding operation, the network may activate the frame discarding operation for the configured DRB(s).
(2) The MAC entity shall for each DRB configured with the frame discarding operation:
   1>if a MAC CE of a discarding command for activating the frame discarding operation of the DRB is received:
      2>indicate the frame discarding information of the DRB to upper layers.

In a further embodiment, regarding a frame discarding operation:
(1) For the PDCP entity configured with a frame discarding operation, the transmitting PDCP entity shall:
   1>for DRBs:
      2>if the discarding command is indicated for the DRB:
         3>start a data discarding timer (e.g., FrameDiscardTimer).

In operation 404, while the data discarding timer is running, the PDCP entity of DRB2 of UE 411 discards a PDCP SDU from the upper layer at UE 411. For instance, regarding a SDU discarding operation:
(1) When a data discarding timer (e.g., FrameDiscardTimer) is running, the data discarding timer expires for a PDCP SDU, or the successful delivery of a PDCP SDU is confirmed by a PDCP status report, the transmitting PDCP entity shall discard the PDCP SDU along with the corresponding PDCP Data PDU. If the corresponding PDCP Data PDU has already been submitted to lower layers, the discarding operation is indicated to lower layers.
(2) For SRBs, when upper layers request a PDCP SDU discarding operation, the PDCP entity shall discard all stored PDCP SDUs and PDCP PDUs. In some embodiments, discarding a PDCP SDU already associated with a PDCP SN causes a SN gap in the transmitted PDCP Data PDUs, which increases PDCP reordering delay in the receiving PDCP entity. It is up to a UE's implementation regarding how to minimize the SN gap after the SDU discarding operation.

In the embodiments of FIG. 4B described above, I frame and P frame are carried on two DRBs respectively. In some further embodiments of FIG. 4B, I frame and P frame are carried on the same DRB1, and the above principles and solutions are also applicable. That is, the discarding command may be used to indicate a frame discarding operation of DRB1.

In some other embodiments of FIG. 4B, in a case that a frame consists of multiple slices, when a BS determines that a slice has not been received completely within a packet delay budget, it only impacts the decoding of the slice in the next frame. Thus, the BS needs to notify the UE of the specific slice. In case of a slice-based traffic model, it is assumed that the slice ID is included in the L2 header of the uplink PDU, and the slice ID of each slice in one frame is different. In this case, the discarding command is used to indicate the specific slice, e.g., the discarding command further includes the slice ID. Upon receiving the discarding command, the PDCP entity of the UE may only discard the PDCP SDU belonging to the specific slice.

FIGS. 5A-5D illustrate exemplary MAC CE and PDCP control PDU including a discarding command in accordance with some embodiments of the subject application.

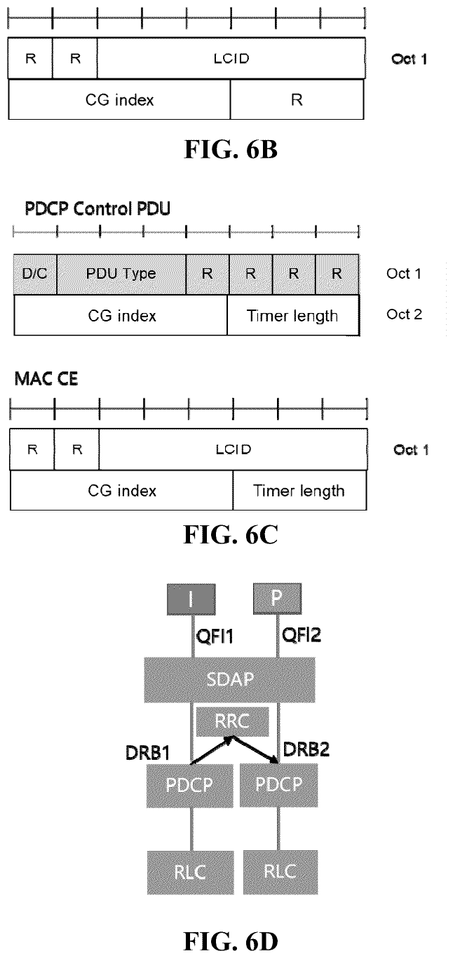

FIG. 5A shows an exemplary MAC CE along with MAC sub-header which carries a discarding command. “LCID” is a logical channel ID field which identifies the type of discarding command in the MAC CE. A field of “DRB ID” indicates the identity of DRB for which the MAC CE applies. The length of the field of DRB ID is 5 bits. In some embodiments, the DRB ID can be replaced with LCH ID of the DRB, e.g., as shown in FIG. 6A. In case of the XR traffic mapped to the same DRB and further mapped to different LCHs, when a UE receives the discarding command with the LCH ID of the DRB, the UE only discards the UL data mapped to the LCH ID of the DRB. In the split BS-CU and BS-DU case, BS-CU may need to notify BS-DU that the incomplete frame reception has occurred on a specific DRB. So that BS-DU can generate the MAC CE.

FIG. 5B shows a further exemplary MAC CE along with MAC sub-header which carries a discarding command. “LCID” is a logical channel ID field which identifies the type of discarding command in the MAC CE. A field of “Dᵢ” indicates the “on” status of a data discarding operation of DRB i, wherein “i” is the ascending order of the DRB ID among the DRBs configured with data discarding operation associated with this MAC entity. The Dᵢ field is set to 1 to indicate that the data discarding operation of DRB i shall be activated. The Dᵢ field is set to 0 to indicate that the data discarding operation of DRB i shall be deactivated.

For example, if there are three DRBs in total, i.e., DRB1, DRB2, and DRB3. If the second row of “D₇ D₆ D₅ D₄ D₃ D₂ D₁ D₀” in the MAC CE of FIG. 5B shows a bitmap “0 0 0 0 0 1 0 1”, this MAC CE indicates that the data discarding operations of DRB1 and DRB3 are activated, while the data discarding operation of DRB2 is deactivated. After receiving this MAC CE, a UE may discard data transmissions of DRB1 and DRB3.

FIG. 5C shows an exemplary PDCP Control PDU which carries a discarding command. In the split BS-CU and BS-DU case, BS-DU may need to notify BS-CU that the incomplete frame reception has occurred on a specific DRB. So that BS-CU can generate a PDCP control PDU. In FIG. 5C, a field of “PDU Type” indicates the type of control information included in a PDCP Control PDU of a discarding command. A field of “DRB ID” indicates an ID of DRB for which the MAC CE applies. The length of the field of “DRB ID” may be 5 bits.

FIG. 5D shows exemplary formats of a discarding command which is used to dynamically indicate a length of a data discarding timer to a UE. In some embodiments of FIG. 5D, the discarding command is used to dynamically indicate a timer length or a scale factor of the data discarding timer. Upon receiving the discarding command, the PDCP entity of a DRB of a UE or the MAC entity of the UE may:
(1) set “Timer Length” indicated in the PDCP Control PDU or the MAC CE as shown in FIG. 5D as a length of the data discarding timer; or
(2) set a length of the data discarding timer to “a scale factor multiplied by a frame discard period”; or
(3) set a length of the data discarding timer to “a scale factor multiplied by a frame arrival period”; or
(4) start the data discarding timer immediately or after a time offset. The time offset may be a default value or configured by the network by RRC message.

In some embodiments of the subject application, due to a hybrid automatic repeat request (HARQ) retransmission over the air interface, the time when the MAC, PDCP, and RRC message arrives at a UE is uncertain. This may cause the UE to start the timer too early or too late. Accordingly, the UE may not discard IP packet(s) of accurate frames(s). The exact time when the UE starts the timer is further indicated in some embodiments. For example, the discarding command may be used to further indicate starting timing (i.e., a start time instance) of a data discarding timer. The PDCP entity of a DRB of the UE starts the data discarding timer at the starting timing indicated in the discarding command. For instance, the starting timing can be relative time for the less overhead of the UE.

In an embodiment, the starting timing is an offset relative to the time when the PDCCH scheduling the PDSCH carrying the discarding command. In a further embodiment, the starting timing is an offset relative to the time when the PDSCH carrying the discarding command is received. For example, if the starting timing of the timer is not included in the discarding command, the relative time can be pre-configured by the network by an RRC message.

In some embodiments, regarding a PDCP discarding operation:
(1) If one or more DRBs are configured with a PDCP discarding operation, the network may send an activation or deactivation command for a PDCP discarding operation, to more flexibly control the PDCP discarding operation for the configured DRB(s), instead of controlling the PDCP discarding operation based on a semi-static timer. The activation or deactivation command can be a new type of MAC CE.
(2) The MAC entity shall for each DRB configured with the PDCP discarding operation:
   1>if a MAC CE of a command for activating the PDCP discarding operation of a DRB configured with PDCP discarding operation is received from the network:
      2>indicate the activation of the PDCP discarding operation of the DRB to upper layers.

For example, an exemplary MAC CE of an activation or deactivation command for a PDCP discarding operation may be shown in FIG. 5B. The MAC CE of one octet is identified by a MAC sub-header with a field of “LCID” indicating the type of the MAC CE. The MAC CE may have a fixed size and include a single octet containing eight D-fields, i.e., a field of “Dᵢ”. The field of Di indicates the activation or deactivation status of the PDCP discarding operation of DRB i, where “i” is the ascending order of the DRB ID among the DRBs configured with the PDCP discarding operation and with RLC entity(ies) associated with this MAC entity. The Dᵢ field is set to 1 to indicate that the PDCP discarding operation of DRB i shall be activated. The Dᵢ field is set to 0 to indicate that the PDCP discarding operation of DRB i shall be deactivated.

In some embodiments, if a PDCP discarding operation is activated for the transmitting PDPC entity of a DRB:
(1) The transmitting PDCP entity shall discard UL PDCP SDU(s) along with the corresponding PDCP data PDU(s) of the DRB. The PDCP SDU(s) or PDU(s) includes at least one of:
   1) the available PDCP SDU(s) or PDU(s) upon receiving the activation command for the PDCP discarding operation; or
   2) the available PDCP SDU(s) from the upper layer after receiving the activation command for the PDCP discarding operation.
(2) The MAC entity shall for each DRB configured with the PDCP discarding operation:
   1>if a MAC CE of a command for deactivating the PDCP discarding operation of the DRB configured with the PDCP discarding operation is received from the network:
      2>indicate the deactivation of the PDCP discarding operation of the DRB to upper layers.

In some embodiments, if the PDCP discarding operation is deactivated for the transmitting PDPC entity of the DRB, the transmitting PDPC entity of the DRB stops the PDCP discarding operation.

In some embodiments, in a case of CU-DU split, BS-CU sends information related to a PDCP discarding operation to the BS-DU via a NR user plane protocol or a NR control plane protocol. For instance, the information related to the PDCP discarding operation may include an indicator of a specific DRB to which the PDCP discarding operation is configured. In one example, BS-DU may generate contents of a MAC CE based on the information related to the PDCP discarding operation.

In some embodiments, regarding a PDCP discarding operation:
(1) If one or more DRBs are configured with a PDCP discarding operation, the network may send an activation or deactivation command for the PDCP discarding operation, to control the PDCP discarding operation for the configured DRB(s), instead of controlling the PDCP discarding based on a fixed time window in time domain. The activation or deactivation command can be a new type of PDCP control PDU.
(2) The PDCP entity shall for each DRB configured with the PDCP discarding operation:
   1>if a PDCP control PDU of a command for activating the PDCP discarding operation of the DRB configured with PDCP discarding operation is received from the network:
      2>the PDCP discarding operation is activated for the transmitting PDPC entity of the DRB;
      2>the transmitting PDCP entity of the DRB discards the UL PDCP SDU(s) along with the corresponding PDCP data PDU(s) of the DRB. The PDCP SDU(s) or PDU(s) includes at least one of:
         the available PDCP SDU(s) or PDU(s) upon receiving the activation command for the PDCP discarding operation; or
         the available PDCP SDU(s) from the upper layer after receiving the activation command for the PDCP discarding operation.
   1>if a PDCP control PDU of a command for deactivating the PDCP discarding operation of the DRB configured with the PDCP discarding operation is received from the network:
      2>the PDCP discarding operation is deactivated for the transmitting PDPC entity of the DRB
      2>the transmitting PDCP entity of the DRB shall stop the PDCP discarding operation.

In some embodiments of the subject application, in a case of a set of CG type 1 configured for a specific LCH carrying the XR traffic, if a BS determines that a UE needs not send IP packet(s) of the correlation frame(s) of the specific LCH, and the correlation frame(s) are decoded dependently of the incompletely received frame, the BS may send a CG prohibiting command to the UE. So that the UE will skip the transmission on the LCH with the CG type 1, and may prohibit triggering a SR corresponding to the LCH according to the CG prohibiting command from the BS within a certain period. It is beneficial for the BS to use the set of CG(s) for the scheduling transmission of other users.

A CG prohibiting command may also be named as “a prohibiting command” or “a CG skipping notification” or the like. For example, the CG prohibiting command includes the LCH ID. A length of a CG prohibiting timer (may also be named as a CG skipping timer or the like) may be configured by a BS via an RRC message. The BS can send a CG prohibiting command by RRC signalling, PDCP control PDU, MAC C, or DCI. A CG prohibiting command may be used to indicate the LCH (e.g., as shown in FIG. 6A), or may be used to further indicate the set of CGs (e.g., as shown in FIG. 6B), or may be used to further dynamically indicate the timer length or the scale factor (e.g., as shown in FIG. 6C).

For example, upon receiving a CG prohibiting command, a MAC entity of a UE may:
1>Start a CG prohibiting timer immediately or after a time offset. The time offset may be a default value or configured by the network by an RRC message.
1>While the CG prohibiting timer is running:
   2>skip the transmission on the LCH with the set of the allowed CG configured by an RRC message.

As long as at least one SR is pending, the MAC entity of the UE shall for each pending SR:
1>if the MAC entity has no valid PUCCH resource configured for the pending SR:
   2>initiate a random access (RA) procedure on the SpCell and cancel the pending SR
1>else, for the SR configuration corresponding to the pending SR:
   2>when the MAC entity has an SR transmission occasion on the valid PUCCH resource for SR configured; and
   2>if sr-ProhibitTimer or the CG prohibiting timer is not running at the time of the SR transmission occasion; and
      4>consider the SR transmission as a prioritized SR transmission.

FIGS. 6A-6C illustrate exemplary MAC CE and PDCP control PDU including a prohibiting command in accordance with some embodiments of the subject application.

FIG. 6A shows an exemplary MAC CE of a CG prohibiting command. “LCID” is a logical channel ID field which identifies the type of the CG prohibiting command in the MAC CE. A field of “LCID of DRB” indicates an ID of a LCH of a DRB for which the MAC CE applies. The length of the field of “LCID of DRB” may be 5 bits.

FIG. 6B shows a further exemplary MAC CE of a CG prohibiting command. “LCID” is a logical channel ID field which identifies the type of the CG prohibiting command in the MAC CE. A field of “CG index” indicates an ID of a set of CG(s). So, the MAC entity of the UE may skip the transmission on the LCH with the set of CG(s) indicated in the CG prohibiting command.

FIG. 6C shows exemplary formats of a CG prohibiting command which is used to further dynamically indicate a timer length or a scale factor of a CG prohibiting timer. Upon receiving the CG prohibiting command, the MAC entity of the UE may:
(1) set “Timer Length” indicated in the PDCP Control PDU or the MAC CE as shown in FIG. 6C as a length of the CG prohibiting timer; or
(2) set a length of the CG prohibiting timer to “a scale factor multiplied by a CG period”; or
(3) start the CG prohibiting timer immediately or after a time offset. The time offset may be a default value or configured by the network by RRC message.

In some embodiments of the subject application, a CG prohibiting command is further used to indicate starting timing (i.e., a start time instance) of the CG prohibiting timer. The MAC entity of the UE may start the CG prohibiting timer at the precise starting timing.

In some embodiments of the subject application, when a UE detects that IP packet(s) of a frame on a DRB is too late to be transmitted within a delay budget, the UE discards IP packet(s) of the future arriving correlation frames on the DRB within a certain period.

In particular, an embodiment assumes that I-frame and P-frame are carried on the same DRB. When the PDCP entity of the DRB discards a PDCP SDU or a PDCP PDU which is too late to be transmitted, the PDCP entity of the UE may:
(1) set a length of a data discarding timer to “(GOP size-j) multiplied by a period”; wherein “j” is the ascending order of the frame in this GOP, e.g., j =1, 2, . . . , GOP size; or
(2) set the length of the data discarding timer to the pre-configured timer length via an RRC message;
(3) start the data discarding timer; or
(4) while the data discarding timer is running: discard the PDCP SDU along with the PDCP PDU.

A further embodiment assumes that I-frame and P-frame are carried on two DRBs respectively, e.g., DRB1 and DRB2 as shown in FIG. 4A. To support the interaction of a discarding indication between two DRBs, a BS sends the correlation information for the DRB1 to a UE via an RRC message. A discarding indication may also be named as “a data discarding indication” or “a frame discarding indication” or “a slice discarding indication” or the like.

The correlation information may include:
(1) the correlation DRB (i.e., DRB2) of the DRB1; and/or
(2) a GOP size, an inter-frame correlation number (e.g., a maximum number of previous frames to which a frame is correlated), a total number of frames in the GOP between a frame and a further frame correlated to the frame, a frame arrival period, and/or a data discarding timer. A specific example is described in embodiments of FIG. 6D.

FIG. 6D illustrates an exemplary flow chart of a frame discard notification between two DRBs in accordance with some embodiments of the subject application. The same as FIG. 4A, I-frame and P-frame are routed to the different two QoS flows, i.e., QFI1 and QFI2, and are further mapped to different DRBs, i.e., DRB 1 and DRB 2. As shown in FIG. 6D, upon an expiry of a PDCP discarding timer, if there's a PDCP SDU and PDU, which is too late to be transmitted, about the PDCP entity of a DRB (e.g., DRB1), the PDCP entity of DRB1 of the UE may:
(1) discard the PDCP SDU and PDU which is too late to be transmitted; and
(2) send a discarding indication to the RRC entity of the UE.

Upon receiving the discarding indication from the PDCP entity of DRB1, the RRC entity of the UE may send the discarding indication to the PDCP entity of the correlation DRB (e.g., DRB2) of DRB1. Upon receiving the discarding indication from the RRC entity of the UE, the PDCP entity of DRB2 may:
(1) start the data discarding timer; and
(2) while the timer is running: discard the PDCP SDUs.

The length of the data discarding timer may be pre-configured for DRB2 via an RRC message or may be dynamically set to “(GOP size—1) multiplied by a frame arrival period” by the RRC entity, the PDCP entity of DRB1 or the PDCP entity of DRB2.

In another embodiment, if a UE decides to perform a discarding operation of the correlation PDCP SDU of a LCH for a period, the UE will skip the transmission on the LCH with the allowed set of CG configured by an RRC message in this period. The UE may send the CG prohibiting report to a BS. The CG prohibiting report may be used to indicate a set of CGs to be skipped to the BS, in order that the BS can be aware that the CG resource(s) is available for other users. The CG prohibiting report may be used to further indicate a length and/or start timing of a CG prohibiting timer, which may also be named as a CG skipping timer. The CG prohibiting report may have similar formats to those of a data discarding command, a CG prohibiting command, or a discarding indication as described above, e.g., in FIGS. 6B and 6C.

In some embodiments of the subject application, a UE skips a transmission on the correlation LCH with the set of allowed CG(s) configured by an RRC message in a period when the PDCP PDU on the LCH carrying the XR traffic is too late to be transmitted, and the UE may further prohibit triggering a SR corresponding to the LCH.

In particular, an embodiment assumes that I-frame and P-frame is carried on the same DRB. Upon an expiry of the PDCP discarding timer, if the PDCP entity of a DRB (e.g., DRB1) discards the PDCP SDU and PDU which is too late to be transmitted, the PDCP entity of DRB1 may indicate the RRC entity to skip CG for the transmission on the LCH of DRB1. Upon receiving the CG prohibiting command from the PDCP entity, the RRC entity of the UE may indicate the MAC entity to skip the CG for the transmission on the LCH of DRB1. Upon receiving the CG prohibiting command from the RRC entity of the UE, the MAC entity of the UE may:
(1) start the CG skipping timer for the LCH indicated in the CG prohibiting command; and
(2) while the CG skipping timer is running: skip transmission for the LCH indicated in the CG prohibiting command with the allowed CG configured by RRC message.

A length of the CG skipping timer may be set to “(GOP size—j) multiplied by a period” by the PDCP entity of DRB1, by the RRC entity of the UE, or by the MAC entity of the UE. Wherein “j” is the ascending order of the PDU set in this GOP. Or, a length of the CG skipping timer may be set to a timer length configured by an RRC message.

As long as at least one SR is pending, the MAC entity of the UE shall for each pending SR:
1>if the MAC entity has no valid PUCCH resource configured for the pending SR:
   2>initiate a RA procedure on the SpCell and cancel the pending SR.
1>else, for the SR configuration corresponding to the pending SR:
   2>when the MAC entity has an SR transmission occasion on the valid PUCCH resource for SR configured; and
   2>if sr-ProhibitTimer or a CG skipping timer is not running at the time of the SR transmission occasion; and
      4>consider the SR transmission as a prioritized SR transmission.

A further embodiment assumes that I-frame and P-frame are carried on two DRBs respectively, e.g., DRB1 and DRB2 as shown in FIG. 4A. To support a discarding notification between two DRBs, a BS should send a discarding indication configuration for DRB1 to a UE. The discarding indication configuration may include:
(1) the correlation DRB (e.g., DRB2) of DRB1; and/or
(2) at least one parameter, e.g., the GOP size, an inter-frame correlation number (e.g., a maximum number of previous frames to which a frame is correlated), a total number of frames in the GOP between a frame and a further frame correlated to the frame, a frame arrival period, and/or a frame discarding timer.

Upon an expiry of a PDCP discarding timer, if the PDCP entity of DRB1 discards the PDCP SDU or PDU which is too late to be transmitted, the PDCP entity of DRB1 may send a discarding indication to the RRC entity, and DRB1 is indicated in the discarding indication.

Upon receiving the discarding indication from the PDCP entity of DRB1, the RRC entity may:
(1) determine DRB2 which is correlated to DRB1 according to the RRC configuration; and
(2) indicate a prohibiting indication for the LCH of DRB2, to the MAC entity.

Upon receiving the prohibiting indication from the RRC entity, the MAC entity may:
(1) start the CG skipping timer; and
(2) while the CG skipping timer is running: skip a transmission for the LCH indicated in the prohibiting notification with the allowed CG configured by an RRC message.

A length of the CG skipping timer may be set to “(GOP size—1) multiplied by a period” by the PDCP entity of DRB1, by the RRC entity, or by the MAC entity. Or, a length of the CG skipping timer may be set to the timer length configured by an RRC message.

In another embodiment, once a UE decides to discard the correlation PDCP SDU for a period, the UE sends a CG prohibiting report to a BS. The CG prohibiting report may be used to indicate a set of CG(s) to be skipped, and may further indicate a length and/or start timing of the CG skipping timer.

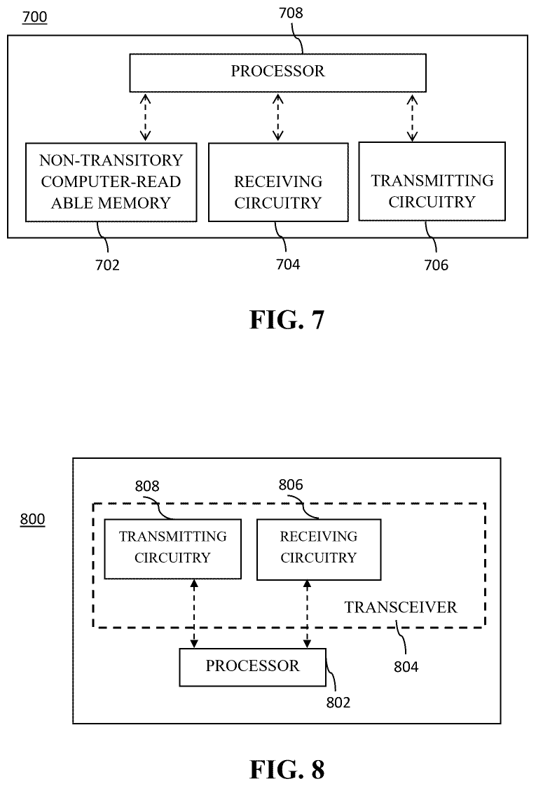

FIG. 7 illustrates an exemplary block diagram of an apparatus 700 for a data discarding operation in accordance with some embodiments of the subject application. As shown in FIG. 7, the apparatus 700 may include at least one non-transitory computer-readable medium 702, at least one receiving circuitry 704, at least one transmitting circuitry 706, and at least one processor 708 coupled to the non-transitory computer-readable medium 702, the receiving circuitry 704 and the transmitting circuitry 706. The at least one processor 708 may be a CPU, a DSP, a microprocessor etc. The apparatus 700 may be a network node (e.g., a BS) or a UE configured to perform a method illustrated in the above or the like.

Although in this figure, elements such as the at least one processor 708, receiving circuitry 704, and transmitting circuitry 706 are described in the singular, the plural is contemplated unless a limitation to the singular is explicitly stated. In some embodiments of the subject application, the receiving circuitry 704 and the transmitting circuitry 706 can be combined into a single device, such as a transceiver. In certain embodiments of the subject application, the apparatus 700 may further include an input device, a memory, and/or other components.

In some embodiments of the subject application, the non-transitory computer-readable medium 702 may have stored thereon computer-executable instructions to cause a processor to implement the methods with respect to a UE or a network node (e.g., a BS) as described or illustrated above. For example, the computer-executable instructions, when executed, cause the processor 708 interacting with receiving circuitry 704 and transmitting circuitry 706, so as to perform the steps with respect to a UE or a network node (e.g., a BS) as described or illustrated above.

FIG. 8 illustrates a further exemplary block diagram of an apparatus 800 for a data discarding operation in accordance with some embodiments of the subject application. Referring to FIG. 8, the apparatus 800, for example a BS or a UE, may include at least one processor 802 and at least one transceiver 804 coupled to the at least one processor 802. The transceiver 804 may include at least one separate receiving circuitry 806 and transmitting circuitry 808, or at least one integrated receiving circuitry 806 and transmitting circuitry 808. The at least one processor 802 may be a CPU, a DSP, a microprocessor etc.

According to some other embodiments of the subject application, when the apparatus 800 is a UE, the processor 802 may be configured: to determine whether to start a timer associated with at least one of an uplink (UL) data discarding function or a configured grant (CG) prohibiting function or a scheduling request (SR) prohibiting function of the UE; to start the timer, in response to determining to start the timer; and to perform at least one of: discarding UL data for a data radio bearer (DRB) to be transmitted when the timer is running; prohibiting a transmission on a logical channel (LCH) associated with one or more sets of CGs or associated with one or more sets of SR resources configured for the UE when the timer is running; or prohibiting a trigger of a SR for the LCH associated with the one or more sets of CGs or associated with the one or more sets of SR resources when the timer is running.

According to some embodiments of the subject application, when the apparatus 800 is a network node (e.g., a BS), the processor 802 is configured: to receive a capability supporting UL data discarding or CG prohibiting of a UE via the transceiver 804 from the UE; and to transmit a first configuration for enabling at least one of a UL data discarding function or a CG prohibiting function of the UE via the transceiver 804 to the UE.

The method(s) of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including”. Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the subject application, but is not used to limit the substance of the subject application.

1. A user equipment (UE) for wireless communication, comprising:
at least one memory; and
at least one processor coupled with the at least one memory and configured cause the UE to:
determine whether to start a timer associated with at least one of an uplink (UL) data discarding function or a configured grant (CG) prohibiting function or a scheduling request (SR) prohibiting function of the UE;
start the timer, in response to determining to start the timer; and
perform at least one of:
discarding UL data for a data radio bearer (DRB) to be transmitted when the timer is running;
prohibiting a transmission on a logical channel (LCH) associated with one or more sets of CGs or associated with one or more sets of SR resources configured for the UE when the timer is running; or
prohibiting a trigger of a scheduling request (SR) for the LCH associated with the one or more sets of CGs or associated with the one or more sets of SR resources when the timer is running.

2. The UE of claim 1, wherein, to determine whether to start the timer, the at least processor is further configured cause the UE to:
determine whether a discarding command corresponding to the DRB or a prohibiting command corresponding to the LCH is received; and
in response to determining that the discarding command or the prohibiting command is received, determine to start the timer.

3.-6. (canceled)

7. The UE of claim 1, wherein the at least one processor is further configured to cause the UE to receive a second configuration a network, and wherein the second configuration includes one of:
information for enabling the UL data discarding function; and
a configuration regarding the timer.

8. The UE of claim 1, wherein the at least one processor is further configured to cause the UE to receive a discarding command corresponding to the DRB via a network.

9. The UE of claim 8, wherein the discarding command includes at least one of:
identity (ID) information of the DRB;
ID information of a slice in a frame to be transmitted when the timer is running;
a start time instance of the timer;
a length of the timer;
a scale factor associated with the length of the timer; or
a period associated with the scale factor.

10. The UE of claim 9, wherein the at least one processor is further configured to cause the UE to:
in response to the discarding command including the ID information of the DRB, discard one or more packet data convergence protocol (PDCP) service data units (SDUs) along with one or more PDCP protocol data units (PDUs) on the DRB; or
in response to the discarding command including the ID information of the slice, discard one or more PDCP SDUs on a DRB to which the slice belongs.

11.-12. (canceled)

13. The UE of claim 1, wherein, to determine whether to start the timer, the at least one processor is further configured to cause the UE to:
determine whether data on a first DRB is too late to be transmitted within a delay budget; and
in response to determining that the data on the first DRB is too late to be transmitted within the delay budget, determine to start the timer.

14. The UE of claim 13, wherein, to discard the UL data to be transmitted when the timer is running, the at least one processor is further configured to cause the UE to:
discard the data on the first DRB when the timer is running; or
discard data on a second DRB correlated to the first DRB when the timer is running.

15. A network node for wireless communication, comprising:
at least one memory; and
at least one processor coupled with the at least one memory and configured to cause the network node to:
to receive a capability supporting at least one of uplink (UL) data discarding or configured grant (CG) prohibiting or scheduling request (SR) prohibiting of a user equipment (UE); and
transmit, to the UE, a first configuration for enabling at least one of a UL data discarding function or a CG prohibiting function of the UE.

16. A user equipment (UE) for wireless communication, comprising:
at least one memory; and
at least one processor coupled with the at least one memory and configured cause the UE to:
determine whether a discarding command corresponding to a data radio bearer (DRB) is received; and
in response to determining that the discarding command for activating a packet data convergence protocol (PDCP) discarding operation of a DRB configured with PDCP discarding operation is received from the network activate of the PDCP discarding operation of the DRB.

17. The UE of claim 16, wherein the discarding command is received via a medium access control (MAC) control element (CE).

18. The UE of claim 17, wherein the MAC CE includes a field of a bitmap, and wherein each bit of the bitmap indicates an activation status or deactivation status of the PDCP discarding operation of DRB i, where i is an ascending order of a DRB ID among DRBs configured with the PDCP discarding operation and with one or more radio link control (RLC) entities associated with the MAC CE.

19. The UE of claim 18, wherein the at least one processor is further configured to cause the UE to:
indicate activation of the PDCP discarding operation of the DRB to upper layers when the MAC CE of a command for activating the PDCP discarding operation of a DRB configured with the PDCP discarding operation is received from a network node.

20. The UE of claim 18, wherein the at least one processor is further configured to cause the UE to:
indicate deactivation of the PDCP discarding operation of the DRB to upper layers when the MAC CE of a command for deactivating the PDCP discarding operation of a DRB configured with PDCP discarding operation is received from a network node.

21. The UE of claim 18, wherein the at least one processor is further configured to cause the UE to:
when a PDCP discarding operation is activated for a transmitting PDCP entity of a DRB, the transmitting PDCP entity of the UE discards uplink (UL) PDCP service data units (SDUs) along with corresponding PDCP data protocol data units (PDUs) of the DRB.

22. A method performed by a network node, the method comprising:
receiving a capability supporting at least one of uplink (UL) data discarding or configured grant (CG) prohibiting or scheduling request (SR) prohibiting of a user equipment (UE); and
transmitting, to the UE, a first configuration for enabling at least one of a UL data discarding function or a CG prohibiting function of the UE.

23. The method of claim 22, further comprising:
transmitting a discarding command corresponding to a data radio bearer (DRB) to the UE, indicating whether to activate or deactivate a packet data convergence protocol (PDCP) discarding operation of the DRB.

24. The method of claim 23, wherein the discarding command is received via a medium access control (MAC) control element (CE).

25. The method of claim 24, wherein the MAC CE includes a field of a bitmap, and wherein each bit of the bitmap indicates an activation status or deactivation status of the PDCP discarding operation of DRB i, where i is an ascending order of a DRB ID among DRBs configured with the PDCP discarding operation and with one or more radio link control (RLC) entities associated with the MAC CE.
